(19) United States
(12) Patent Application Publication
(10) Pub. No.: US 2009/0096257 A1
(43) Pub. Date: Apr. 16, 2009

(54) SUN VISOR FOR STROLLER

(76) Inventors: ILKA GORDON, BEACHWOOD, OH (US); LINDSEY E. FRICK, LAKEWOOD, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/249,697

(22) Filed: Oct. 10, 2008

Related U.S. Application Data
(60) Provisional application No. 60/978,807, filed on Oct. 10, 2007.

(51) Int. Cl. A47C 7/66; B60J 3/02

(52) U.S. Cl. 297/184.12; 297/184.13; 296/97.6

(57) ABSTRACT

A sun visor for a stroller is attachable to the awning (also referred to as canopy) of the stroller and can be removed from the stroller, including a partially transparent light attenuating visor material configured for attachment to a stroller, and a fastener in the form of respective pairs of magnets held to the visor and positionable at opposite surfaces of the awning to hold to each other and, thus, to hold the shield to the awning, or in the form of resilient clips to hold to the awning or support structure thereof. A method of shielding a stroller from sunlight, UV, heat and glare as well as wind by positioning a shield in protective relation to a seat area of the stroller.

### CROSS-REFERENCE TO RELATED APPLICATION

This application claims the benefit of U.S. Provisional Patent Application Ser. No. 60/978,807, filed Oct. 10, 2007, the entire disclosure of which is hereby incorporated by reference.

### BACKGROUND OF THE INVENTION

An age-old problem for parents with small children is in transporting them without having to carry them. Historically, the perambulator or baby carriage was used; devices of this type resembled a crib with wheels, a handle, and a cover, and the baby was laid in the carriage for transport. More recently, parents typically employ a stroller for this purpose. Strollers of a wide variety of styles have been developed, but the basic stroller generally includes a cloth seat, suspended within a wheeled frame, and a restraint of some type to keep the child in the seated position. Other solutions include front carriers, sling carriers, and backpack carriers, all of which have their own drawbacks, primarily because the parent must bear the burden of the child's weight. As the child grows older, comfort for the parent becomes an issue.

Current baby strollers often contain an awning to shield the child from the sun but on bright days, when the child is facing the sun, the sun's glare shines in the child's eyes making him/her extremely uncomfortable. The existing awning does not extend far enough to shield the child's face from the brightness and some of the dangerous UV rays of the sun. There exists a need to alleviate this problem.

### BRIEF DESCRIPTION OF THE DRAWINGS

FIG. 1 is a three dimensional view of the stroller and attached visor, in accordance with an embodiment of the present invention.

FIG. 2 is a plan view of the visor complete with attachment clips, in accordance with the present invention shown in FIG. 1.

FIG. 3 is a plan view of an attachment clip, in accordance with the present invention shown in FIG. 1.

FIG. 4 is a plan view of an alternative attachment clip, in accordance with an embodiment of the present invention.

FIG. 5 is a plan view of an alternative attachment clip which allows the visor to pivot away from the stroller, in accordance with an embodiment of the present invention.

FIG. 6 is a three dimensional view of the stroller and another embodiment of visor attached thereto in accordance with another embodiment of the invention.

FIG. 7 is a schematic section view of the attachment mechanism for attaching the visor of the embodiment of FIG. 6 to the stroller.

FIG. 8 is a plan view of a visor according to the embodiment of FIG. 6 showing further details of the attachment mechanism.

FIGS. 9 and 10 are, respectively, fragmentary isometric views or perspective views of attachment mechanism used in the embodiment of FIG. 6.

FIG. 11 is a schematic isometric or perspective view of a visor mounted on an awning that is in retracted mode.

FIG. 12 is a schematic isometric or perspective illustration of a visor in accordance with respective embodiments hereof in rolled, stored mode.

### DETAILED DESCRIPTION

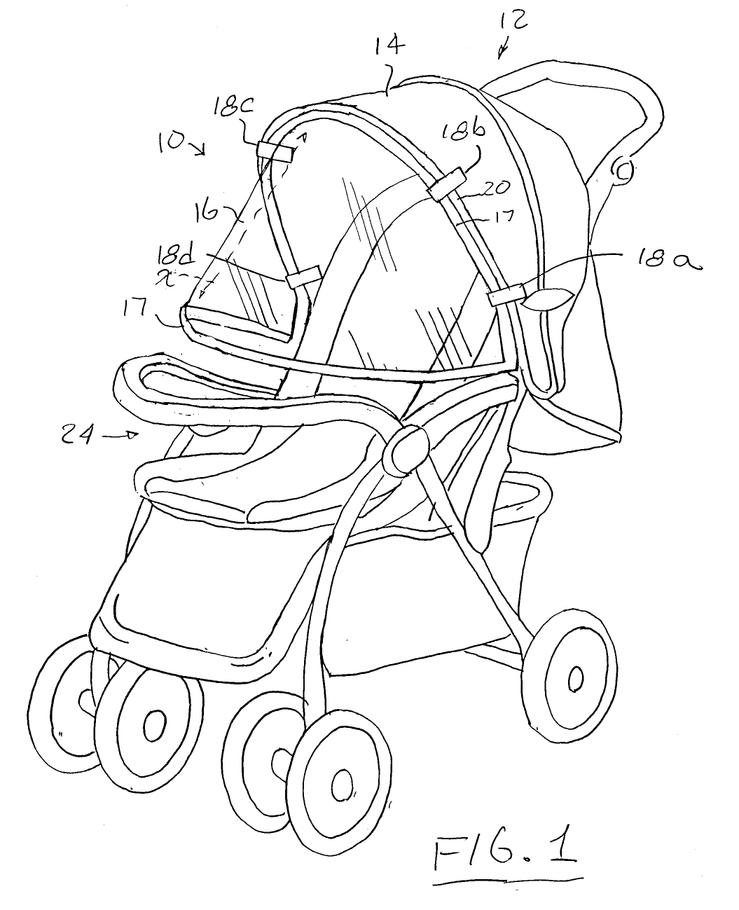

FIG. 1 illustrates a sun visor 10 for a typical baby stroller 12, complete with awning 14, according to the present invention. The awning is shown fully extended before the invention is clipped on. The sun visor 10 is attached to fully extended awning 14 and is designed to shield a child sitting in the stroller from some solar rays, some UV rays, glare, and to reduce the heat inside of the stroller, beneath the awning 14. The visor 10 is constructed of a flexible and bendable plastic material 16 (also referred to below as “visor material,” “shield,” or “shield material”) that may be bent to adapt to the width of almost any awning used with a standard baby stroller. Additionally, visor 10 may be tinted any desired color.

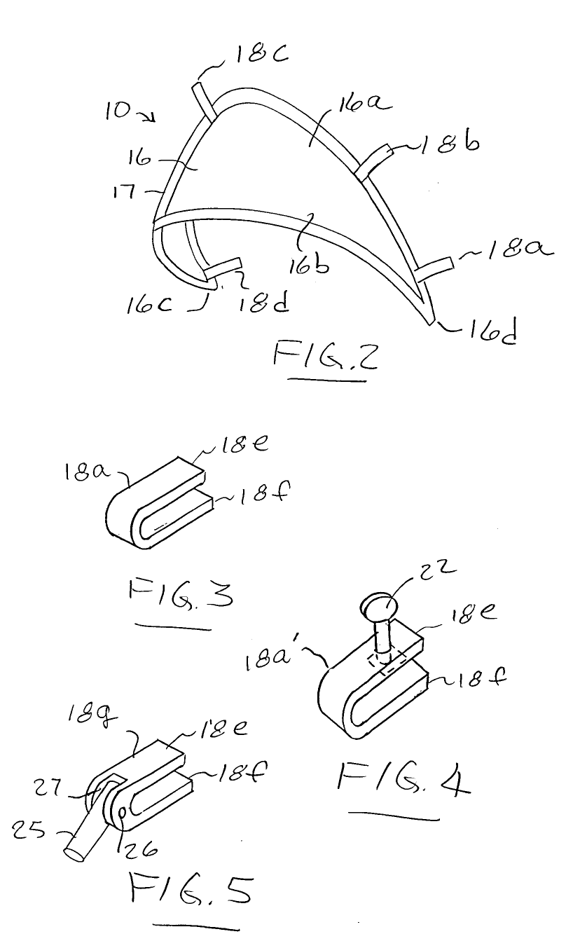

The visor 10 is shaped, as shown in both FIGS. 1 and 2, into an inward curved or concave shaped surface with an upper and lower edge 16a and 16b, respectively, that meet at two end corners 16c and 16d. Preferably, the end corners 16c and 16d are rounded.

According to the invention, a flexible strip 17 can be provided to cover the edges 16a, 16b and corners 16c, 16d of the visor 10 and ensure that no sharp edges are exposed. The material of the flexible strip 17 can be, for example, a plasticized tape, cloth or a strip of flexible plastic having a groove to receive the edges 16a and 16b. It is also within the terms of the invention to form the visor 10 without a flexible strip 17.

Preferably, the sun visor 10 is constructed of a strong, waterproof flexible plastic material such as for example, a polyethylene plastic or a plastic urethane or polycarbonate film. The plastic material 16 of visor 10 is selected to generally prevent or limit solar rays, UV rays and glare from passing there through.

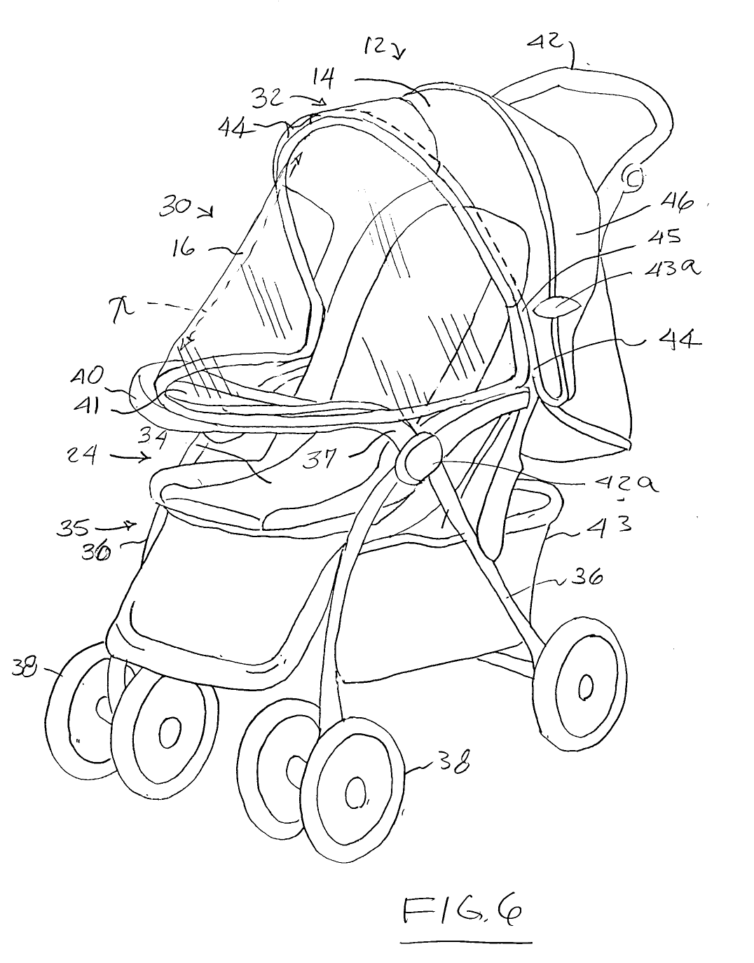

The visor 10 includes a means to removably attach the visor to the stroller 12 and more particularly to the awning 14. In the embodiment shown in FIG. 1, the visor 10 is attached to awning 14 by means of four substantially identical clips 18a, 18b, 18c, and 18d (18a-18d), located about the visor 10 material 16. The clips, as shown in FIG. 3, are generally u-shaped and constructed of a flexible material such as plastic, wood or metal whereby the legs 18e and 18f are biased towards each other so that they will tightly clasp the awning support 20 which is disposed around the edges of the awning.

The clips 18a-18d can be mounted to the visor in any manner such as for example through holes in the visor or glued to the visor or bolted to the visor. The inner surface of the clips can include ridges (not shown) to more firmly secure the clips to the awning. Although the clips can be securely fastened to the awning support, they can be easily removed by the user so that the visor can be stored away or mounted to a different baby stroller.

While u-shaped clips, as shown in FIG. 3 are suitable, they can also include threaded screws 22, as shown in FIG. 4, to more firmly lock the clips 18a′, for example, into place.

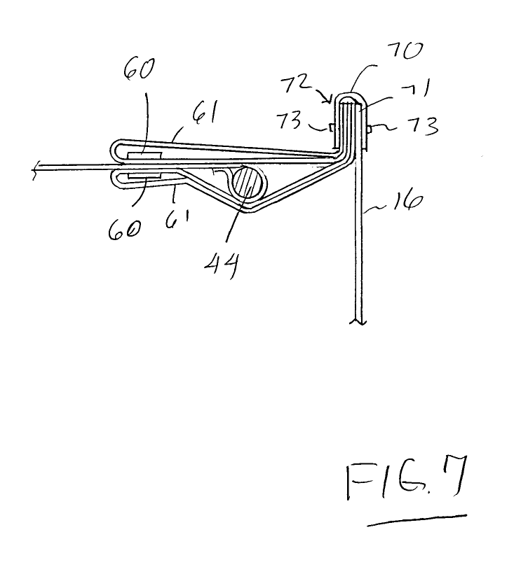

It is also desirable that the clips 18a-18d are attached so that the visor 10 can pivot upward with respect to the awning and away from the seat area 22 of the stroller 12 so that a child can be easily placed into or taken out of the seat of the stroller. To this end, the clips 18g (compared to clips 18a-18d), as shown in FIG. 5, can include a hinged element 25 which can pivot with respect to the clips, by means such as a pivot pin 26 extending through a slot 27 in the clip. Then, when the hinged element 25 is attached to the visor, similar to clips 18a-18d, the visor can be pivoted away from the stroller as mentioned before.

While unshaped clips are illustrated, it is within the terms of the present invention to use any type of connector to removably or permanently attach the visor 10 to the awning 14.

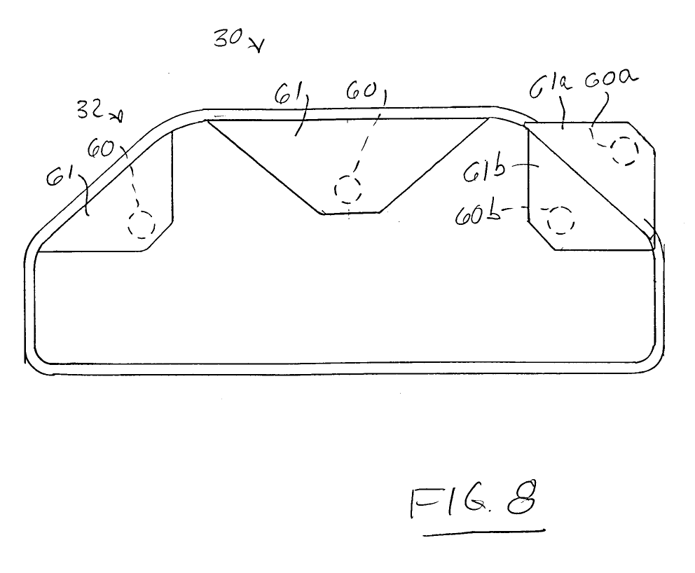

Turning to FIG. 6, another embodiment of sun visor 30 that is attached to a stroller 12 at the awning 14 thereof is shown. The sun visor 30 includes sheet material 16 and an attachment mechanism 32, which will be described in greater detail below.

Briefly referring to the stroller 12 in FIG. 6, the stroller includes a seat area 24, for example, within which a child may sit or if the seat 34 is folded down, may lie. Many strollers have the capability of providing a seated position and a lying position, as is well known. The stroller 12 includes a support structure 35, for example, including a number of support struts 36 as part of a frame 37 for the stroller, and a number of wheels 38. The support structure 35 also may include a protective bar 40 that may include, be or carry a tray 41. A handle 42 may be attached to the support structure to facilitate moving the stroller, e.g., pushing it along a path, etc. A basket 43 also may be carried by the support structure 35.

As is well known, strollers often have an awning or a canopy, such as that shown at 14 in the drawings. The awning shown in FIG. 6, for example, may include a fabric or relatively flexible or corrugated plastic or other material that can pivot forward or backward relative to the handle 42 about a pivot connection 43a. The pivot connection 42a may connect a support rod or bar 44 for the awning 14 to the support structure 35, e.g., to part of the frame 37, of the stroller 12 in a conventional manner. A clip 43a may be used to hold the forward edge 45 of the awning in retracted or backward orientation such that it is pulled back to the otherwise relatively fixed portion 46 of the awning or back of the stroller. The portion 46 may be used to provide a wind barrier to block wind from blowing toward the seat area from the back of the stroller. The portion 46 also may be light blocking material so that sun does not impinge on the seat area 24 from the back of the stroller.

The awning 14 is attached at its forward edge area 45 to the awning support bar 44. The awning support bar 44 may be a rod of metal, a plastic bar that is curved, or some other relatively ridged member that is concave, for example, curved or folded in multiple sections, to circumscribe a portion of the seat area 24 above the area where a child would be sitting or lying. The support bar 44 may pivot about the pivot connection 43a forward and backward, e.g., or toward the front of this stroller or toward the handle 42, respectively.

The awning forward edge 45 is attached to the awning support bar 44, for example, by glue or other adhesive material, by stitching (sewing), by riveting, by welding, by folding the forward edge about the awning support bar so that the awning support bar is enclosed within awning material, which in this case is wrapped around the awning support bar and is adhered to itself by adhesive, stitching, welding, riveting, etc.

The sun visor 10, 30 (FIGS. 1 and 6, for example) solves a problem of providing attenuation of sunlight, for example, that is impinging on the stroller 12 in a direction toward a child in the seat area 24. The child may be sitting or lying, and depending on the particular shape and size of the sun visor 30, for example, and the manner in which it is adjusted, for example, with the awning 14 or some other part of the stroller, attenuation of sunlight on the child can be achieved. Reference to sunlight may include visible light, ultraviolet light, infrared light (heat), glare, etc., for example. The extent of light attenuation may depend on the particular material of which the sun visor 30 is made. For example, typical material used for conventional sunglasses may provide light attenuation. Other typical materials used for sunglasses may provide both attenuation of visible light and ultraviolet light. Materials also are known that provide attenuation or reflection of infrared energy. Furthermore, the sheet material 16 of which the sun visor 30 is formed may be of an optical polarizing material, for example, as that conventionally used in polarized sunglasses. Other types of materials also may be used for the sheet material 16 of the sun visor 30. Several materials are mentioned elsewhere herein.

The size and shape of the sheet material 16 forming the sun visor 30 may be different for different respective strollers 12. However, the sheet material 16 may be reasonably flexible and forgiving allowing it to be bent or distorted in a manner to allow it to fit in the area from the awning 14 generally forward and generally downward in the manner illustrated in FIG. 6, for example, a desired amount. Such desired amount may be represented, for example, along an axis x, which is referred to as the “height” of the sun visor 30. A larger height may provide for extending of the sun visor from the awning all the way to the tray 40; and a smaller height may allow some gap between the bottom edge or leading edge of the sun visor 30 and the tray 40, as may be desired.

The sun visor 30 and the sheet material 16 of which it is formed may be similar to the sun visor 10 and sheet material 16 described above with respect to FIG. 1, for example. However, a difference between the two sun visors is that the sun visor 30 includes attachment mechanism 32 that facilitates attaching the sun visor 30 to an awning 14 and to the support bar 44 thereof, as will be described below.

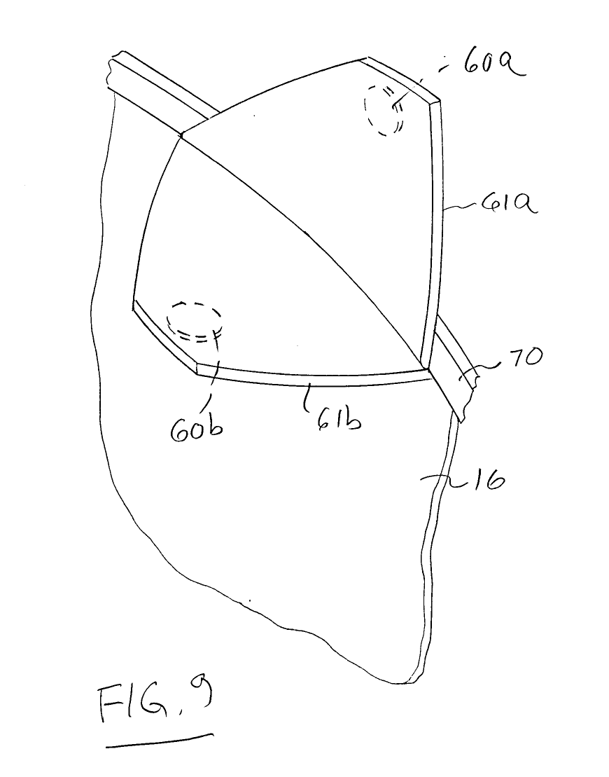

The attachment mechanism 32 to attached the sun visor 30 to the support bar 44 and awning 14 includes a number of magnets 60 and flaps or tabs 61 for material that carried the magnets. In the manner illustrated in FIGS. 6 and 7, for example, respective pairs of magnets 60 are placed in magnetic coupled relation to each other on opposite sides or surfaces of the awning 14 so as to hold respective pairs of flaps or tabs 61 at opposite sides or surfaces of the canopy at a location rearward of the awning support bar 44. In FIG. 6 two of the flaps or tabs 61 (referred to as flaps below) are illustrated. The manner of positioning and using the magnets 60 and flaps 61 to hold the sun visor 30 to the canopy 14 will be described below with respect to FIG. 7.

Initially, though, reference is made to FIGS. 8, 9 and 10 where the sun visor 30 is shown with the respective magnets 60 and flaps 61. The flaps 61 are triangular in shape to facilitate distributing force along an extent of the visor material 16 and to enhance connection to the visor material. The flaps may be more like rectangular tabs, if desired. Each flap includes a hollow area between two layers of fabric, for example, in which a respective magnet is located. The magnets may be glued or otherwise fastened within such hollow area in respective flaps so they will align with respective other magnets of a respective pair of flaps. Being within the flaps, the magnets are not easily touched by hand, thus avoiding touching by a child, and tend not to be directly exposed to the atmosphere or moisture, etc., to avoid rust or other damage to the magnets.

Referring to FIGS. 7-10, the sun visor 30 includes the light attenuating sheet material 16 and the attachment mechanism 32. The attachment mechanism 32 includes the illustrated three pairs of magnets 60 and three pairs of flaps 61. In FIGS. 8, 9 and 10 magnets 60a, 60b are the pair of magnets 60 for one of the pair of flaps 61, which includes the illustrated flaps 61a, 61b. The views in FIGS. 8, 9 and 10 are not necessarily at the same location on the sun visor 30 as the three pairs of magnets and flaps shown in FIG. 8; rather, the illustrations in FIGS. 8, 9 and 10 are somewhat schematic to illustrate the arrangement of magnets and flaps relative to the sheet of material 16 of the sun visor 30.

In using the respective pairs of magnets 60 and pairs of flaps 61, as is illustrated in FIG. 7, one flap 61a is above the awning material 14 and one flap 61b is beneath the awning material. The flaps 61a, 61b are aligned with each other so that they tend to attract toward each other and to hold the flaps 61a, 61b to the material of which the awning 14 is made. The flap 61b is positioned so that it is beneath the awning support bar 44, as is illustrated in FIG. 7 so that in effect the awning support bar 44 and a portion of the awning that is between the flaps 61a, 61b are somewhat captured by the attachment mechanism 32 as the magnets 60a, 60b hold to each other through the awning material.

As also is illustrated in FIG. 7, the awning material 14 wraps about or around the awning support rod 44 having an attachment portion 62 that is adhered by adhesive, stitching, welding, or some other manner to the major extent of the awning material, to the awning support bar 44, or is otherwise held to the awning support bar 44.

As is seen in FIGS. 7 and 8, a binding material 70 may circumscribe the perimeter edge 71 of the sheet material 16. The binding materials 70 may be a fabric material, plastic material, rubber material, or some other material that protects the edge of the perimeter 71 to avoid damage and also avoids the possibility of a sharp edge that could cause cutting, etc. to a user. The binding material 70 also attaches the material forming the flaps 61a, 61b to the sheet material 16 of the sun visor 30 at the area of the perimeter edge 71. As is illustrated in FIG. 7, the material of which the respective flaps 61a, 61b are made is secured to the sheet material 16 by a wrapping of the binding material 70 about the edges, which are generally indicated at 72 of the respective flaps. Stitching, which is schematically shown at 73, may be used to hold the binding 70 and the edges 72 of the flaps to the perimeter edge area 71 of the shield material 16. The stitching may be applied using an appropriate sewing machine that sews fabric thread, plastic thread, metal thread, or other material in the manner represented at 73. If desired, rivets, adhesive, or other technique may be used to adhere the binding and the flaps to the shield material 16. Where there is no flap material at the area of the perimeter edge 71, the binding 70 alone may be adhered to the shield material 31, as is shown, for example, in FIG. 8, e.g., by continued stitching 73 mentioned above.

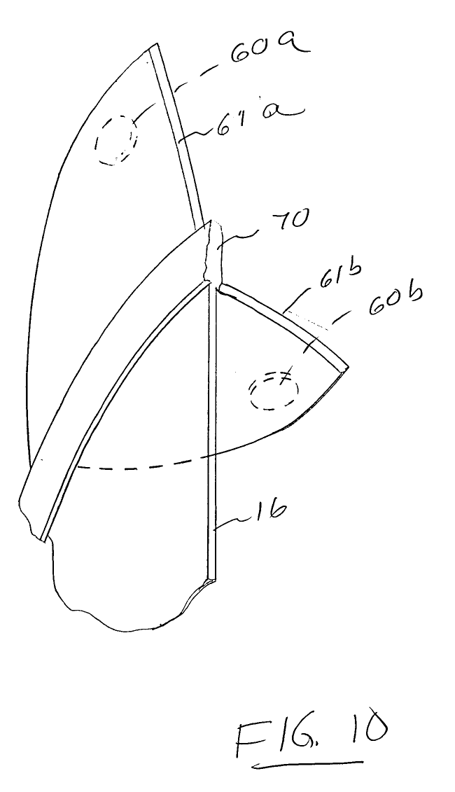

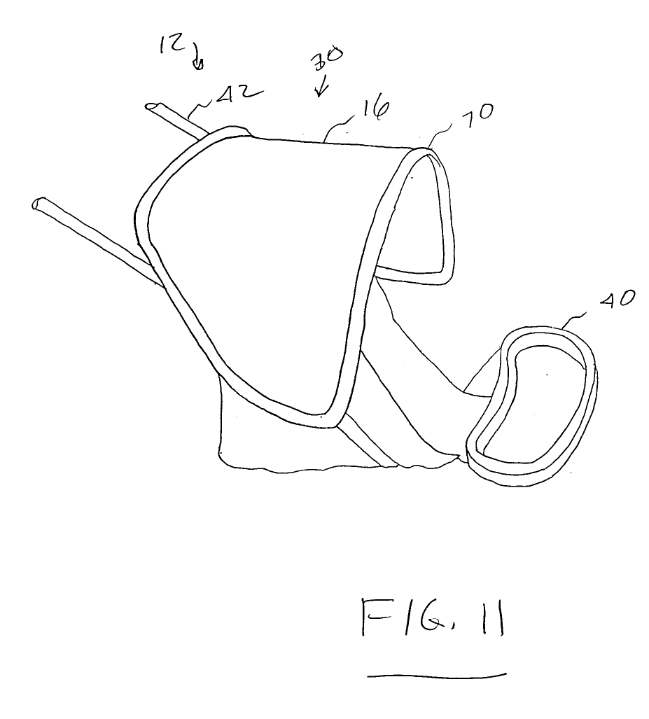

Briefly referring to FIGS. 9 and 10, an exemplary pair of flaps 61a, 61b and of respective magnets 60a, 60b are illustrated. In FIG. 9 the view is fragmentary and schematic looking somewhat from the upper rear or back of the stroller 12 relative to the illustration of FIG. 6. FIG. 10 is a view looking somewhat schematically from the lower front looking upward at the sun visor 30 relative to the illustration in FIG. 6.

The magnetic strength of the respective magnets 60 is sufficiently great so that the respective pairs of magnets hold relatively securely to the awning 14 in the manner illustrated and described above. It is desired that the sun visor 30 would be retained securely without falling off. However, the holding strength of the magnets should be sufficiently weak to allow a user to pry apart the magnets so that the sun visor 30 can be removed from the stroller 12, as desired.

The polygonal shape of the sheet material of which the shield 16 is made is useful to help hold the binding material 70 on the shield. Thus, the binding material will tend not to roll off or pry off usually without an intentional effort to do so. Furthermore, the stitching 73 helps to securely retain the binding material to the shield material 16.

The material of which the shield 16 is made may be virtually any desired thickness. A thinner material tends to be more flexible, whereas a thicker material may be more rigid. In an embodiment the material 16 is ultraviolet protection rated, has a desired percent of light transmission and light blocking or attenuation feature, may have a color tint and may have optical clarity of a plastic film. Materials of which the shield may be made of polyester material, vinyl material, and/or polycarbonate material. In one example, the shield material is polyester having a thickness on the order of about 4 to 8 mils, is optically clear, is tinted charcoal, and offers approximately 98% ultraviolet protection.

The fabric material of which the flaps 61 are made may be polyester, cotton, vinyl, or a combination of any of those materials or other fibers. In an example, the material of which the flaps 61 are made is a polyester/cotton blend.

The material of which the binding material 70 is made may be, for example, canvas, polyester, rayon, vinyl, cotton, or a combination of any of those or other fibers. In an example, the binding material is a vinyl material.

The magnets 60 may be of any size, shape, grade or pull force. Exemplary materials include neodymium, ceramic, flexible, SmCo cobalt or AlNiCo material (aluminum nickel cobalt). The magnets 60 may be coated with any type of metal, plastic or rubber, as is desired. Several non-limiting examples of magnets and magnet material include one or more of the following:

Neodymium (rare earth) magnets, ceramic (hard or flexible) magnets, SmCo Cobalt, or AlNiCo magnets. The magnets can be coated with any type of metal, plastic or rubber. An exemplary magnet is 0.75 inch diameter by 0.125 inch thick Neodymium iron, boron, NdFeB disc magnet N42. Grade N42, N40, N38, N35, or other possible magnets may be used. Grade N42 is about 20% stronger than N35. BrMax: 13200 gauss magnets may be used. Nickel-copper-nickel triple layer coated magnets may be used.

Depending on the length of the dimension X (FIG. 6 (also appearing somewhat as height in that drawing figure)), the shield may come all the way down to the tray 40 of the stroller 12 or there may be an air gap provided, e.g., as is illustrated in FIG. 1, between the bottom edge of the shield and the tray or support bar 40 of the stroller to allow for greater circulation of air to the area where the child is seated or lying. The greater the height dimension X, the greater extent of blocking wind blowing toward the face of the child.

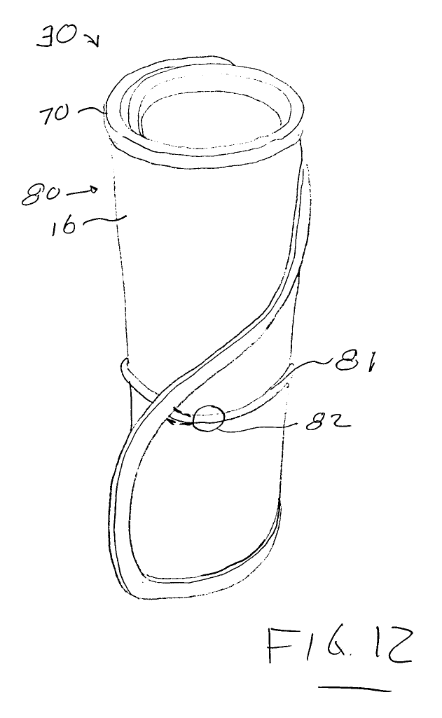

Briefly turning to FIG. 11, it will be seen that the sun visor 30 has sufficient flexibility to allow it to pivot with the awning 14 as the awning is retracted toward the rear of the stroller 12 or extended toward the front of the stroller 12. In FIG. 6 the awning 14 is moved relatively to a forward-most extent of the awning so that the sun visor is fully in place in front of the seating area of the stroller. In FIG. 11, though, the awning 14 is retracted toward the rear of the stroller and the sun visor has been retracted to the rear of the stroller.

Briefly referring to FIG. 12, the sun visor 16, 30 is relatively flexible and can be rolled into a tubular shape 80, as is illustrated in that drawing. Also, a resilient band 81 may be wrapped about the tubular shape. The band may be retained on the sun visor at an opening 82 in the shield material 16. Therefore, the band 81 may be readily available whenever it is desired to roll up the sun visor 16, 30 to the stored tubular shape illustrated in FIG. 12; and the band resiliently can be expanded to remove it from retaining the sun visor in the rolled cylindrical shape 80 shown in FIG. 12 thereby to allow the sun visor to be opened to the orientation shown in FIGS. 1 and 6 for use of the sun visor. The flaps 61 are not shown in FIG. 12, as they are stored in the cylindrical shape 80.

It will be appreciated that in the event there is no awning, the sun visor 16, 30 may still be attached to the top portion of a stroller in the manner described above, e.g., to a portion of the support structure, etc., at an upper portion of the stroller 12.

The embodiments in which an exclusive property or privilege is claimed are, as follows:

1. A sun visor for a stroller, comprising
a partially transparent light attenuating material configured for attachment to a stroller, and
a fastener configured to attach said light attenuating material to a stroller in position to attenuate light and to permit removal of the light attenuating material.

2. The sun visor of claim 1, wherein the stroller has a seat area for a child, and the light attenuating material and fastener are configured to attach the light attenuating material to attenuate light impinging toward the seat area.

3. The sun visor of claim 2, wherein the fastener comprises magnets positionable in magnetically connected relation.

4. The sun visor of claim 3, further comprising flaps carrying respective magnets, the flaps configured for positioning about a support part of the stroller.

5. The sun visor of claim 4, respective pairs of flaps configured to extend on opposite sides of the stroller awning to hold to each other with the awning.

6. The sun visor of claim 5, further comprising binding material about a perimeter of the light attenuating material configured to cooperate with the flaps to hold them to the light attenuating material.

7. The sun visor of claim 4, wherein the light attenuating material comprises material having a degree of rigidity to tend to hold its shape while fastened to the stroller.

8. The sun visor of claim 1, further comprising a retention band attached to the light attenuating material and positionable about the light attenuating material in rolled, storage mode to hold the same in such mode.

9. The sun visor of claim 1, said fastener comprising a number of clips configured to attach the light attenuating material to an awning of the stroller.

10. The sun visor of claim 9, said fastener comprising a number of resilient clips configured to attach the light attenuating material to an awning support bar of the stroller.

11. The sun visor of claim 9, wherein the clips are resilient.

12. The sun visor of claim 9, wherein the clips include a pivot configured to facilitate pivoting of the light attenuating material relative to the awning of the stroller.

13. The sun visor of claim 1, wherein the light attenuating material comprises a partially transparent shield having a light attenuation characteristic.

14. The sun visor of claim 13, wherein the shield has UV attenuation characteristic.

15. The sun visor of claim 14, wherein the shield has heat blocking characteristic.

16. The sun visor of claim 13, wherein the shield is polycarbonate material.

17. A method of shielding a seat area of a stroller, comprising temporarily attaching a shield of light attenuating material to an awning portion of the stroller.

18. The method of claim 17, wherein said temporarily attaching comprises placing respective pairs of magnets in magnetic coupling relation on opposite sides of the awning portion of the stroller such that the attractive force between respective pairs of magnets retains the shield to the awning.
